(19) United States
(12) Patent Application Publication
(10) Pub. No.: US 2013/0328252 A1
(43) Pub. Date: Dec. 12, 2013

(54) FURNACE DIRECT EVACUATION SYSTEM

(71) Applicants: Kenneth A. Burns, Taylor Ridge, IL (US); Susan Marie Tucker, Moline, IL (US); Cache Child Folkman, Bettendorf, IA (US)

(72) Inventors: Kenneth A. Burns, Taylor Ridge, IL (US); Susan Marie Tucker, Moline, IL (US); Cache Child Folkman, Bettendorf, IA (US)

(73) Assignee: SSAB Enterprises, LLC, Lisle, IL (US)

(21) Appl. No.: 13/494,258

(22) Filed: Jun. 12, 2012

(51) Int. Cl. F27D 17/00

(52) U.S. Cl. 266/157

(57) ABSTRACT

An evacuation system for an electric arc furnace that includes a combustion chamber downstream of the electric arc furnace, for receiving exhaust comprising gas and particulate from the electric arc furnace. The evacuation system also includes a dropout section downstream of the combustion chamber, for receiving the exhaust from the combustion chamber, for collecting the particulate, and for allowing the gas to pass through the dropout section to an exhaust duct.

### BACKGROUND

When scrap steel is melted in an Electric Arc Furnace (EAF), carbon monoxide (CO), as well as certain amounts of carbon, natural gas, pieces of scrap and slag, etc. are generated but may not be fully consumed in the process and are consequently vented outside the EAF. In the prior art (see FIG. 1), these materials typically first enter a combustion chamber 110 where the larger pieces of particulate 150 are burned or fall out into a dropout box 120. The remaining gases and finer particles pass out of the combustion chamber 110, with flames, through an exhaust ducting system 130 lined with water-cooled panels 140 and then move on to the baghouse.

A number of design flaws have been noted in conventional evacuation systems for EAFs. For example, some evacuation systems, such as the evacuation system 100 shown in FIG. 1, are too small. This increases the velocity of air movement inside the ducting, not allowing enough time for larger pieces of particulate 150 to fall out into the dropout box. Consequently, the particulate 150 can accumulate in the exhaust ducting 130, eventually resulting in a clog, making the entire venting system ineffective. Accessing the water-cooled panels 140 and clogs, and other maintenance work in conventional evacuation systems such as system 100, is very difficult—requiring significant effort both in terms of man-hours and effort to clean. In terms of maintenance, personnel assigned to perform routine cleaning of the evacuation system—and the dropout box 120 and exhaust ducting 130 in particular—use pneumatic jackhammers and shovels in a confined space. The labor intensity of this exercise often requires incremental, “confined space” permit applications and 12-16 hours of routine (e.g. monthly) downtime.

Moreover, because EAF evacuation ducting is typically filled with flames from the EAF, conventional EAF evacuation systems typically make extensive use of water-cooled paneling 140. This inevitably leads to water leaks, both inside and outside the ductwork, which puts increased demand on the remaining water systems within the facility to cool the necessary components.

Further, the high speed of escape gases through evacuation system 100 can intensify corrosion and result in increased maintenance on ducting walls. The water-cooled panels 140 in evacuation system 100 typically last only about 18 months and can cost well over $100,000 each. Replacement of these panels can require 72-80 hours of downtime to perform, in an environment in which plant downtime translates into lost revenue.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Described herein is technology for, among other things, an evacuation system for an electric arc furnace that includes a combustion chamber downstream of the electric arc furnace, for receiving exhaust comprising gas and particulate from the electric arc furnace. The evacuation system also includes a dropout section downstream of the combustion chamber, for receiving the exhaust from the combustion chamber, for collecting the particulate, and for allowing the gas to pass through the dropout section to an exhaust duct.

The dropout section may have an airspeed therethrough of less than 3100 feet per minute, and preferably less than 2100 feet per minute, and more preferably equal to or less than approximately 2050 feet per minute.

The dropout section defines an internal chamber which may have a volume greater than 4000 cubic feet, and preferably greater than 5800 cubic feet, and more preferably equal to or greater than approximately 5870 cubic feet.

The dropout section may include an upper portion and a lower portion. The lower portion may include an internal wall, an internal floor and a pre-fired low cement castable panel disposed along at least a portion of the floor and/or the wall. The panel may have a channel running along at least a portion of an outward-facing side thereof to allow air to pass therethrough to convectively cool the panel.

The panel may be a wall panel disposed along at least a portion of the wall of the lower portion, and the lower portion of the dropout section may also include a pre-fired low cement castable floor panel disposed along at least a portion of the floor thereof. The floor panel may have a channel running along a floor-facing side and a wall-facing edge thereof that generally aligns with the channel of the wall panel so that air passes between the respective channels of the wall panel and the floor panel to convectively cool both the wall panel and the floor panel. In a preferred embodiment, the walls and floor of the lower portion of the dropout section are substantially lined with the pre-fired, low cement castable panels. In one embodiment, the upper portion of the dropout section may include a water-cooled panel disposed along at least a portion of a wall thereof.

Further, the wall of the dropout section may include an air vent passing therethrough that is generally aligned with the channel of the wall panel so that air passes between ambient atmosphere outside the dropout section and the channel of the wall panel, through the air vent.

The panel may also be a first floor panel disposed along at least a portion of the floor, and the lower portion of the dropout section may also include a second, pre-fired, low cement castable floor panel disposed along at least a portion of the floor of the lower portion and adjacent to the first floor panel. The second floor panel may likewise have a channel running along at least a portion of a floor-facing side thereof, which allows air to pass therethrough to convectively cool the second floor panel. The lower portion of the dropout section may also include a drainage trench disposed within the floor of the lower portion and below at least a portion of the channels of the first and second floor panels so that a fluid can pass between one or more of the channels of the floor panels and a space between the first and second floor panels and the drainage trench. The fluid may be air, such that the passage of the air between the floor panels and the drainage trench convectively cools the floor panels. The fluid may also, or alternatively, be water, such that the drainage trench drains the water away from the floor panels.

In one embodiment, the dropout section may have a door sufficiently large to permit ingress and egress of a motorized skid loader into and out of the dropout section. The door may include a water-cooled panel disposed on an inward-facing side thereof.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a cross-sectional view of a conventional electric arc furnace direct evacuation system;

FIG. 2 is a cross-sectional view of an improved electric arc furnace direct evacuation system, in accordance with various embodiments of the present invention;

FIG. 3 is a perspective view of a lower portion of a dropout section of the improved electric arc furnace direct evacuation system of FIG. 2, in accordance with various embodiments of the present invention;

FIG. 4 is a plan view of a lower portion of a dropout section of the improved electric arc furnace direct evacuation system of FIG. 2, in accordance with various embodiments of the present invention;

FIG. 5A is a first perspective view of a cement wall panel for a dropout section of an electric arc furnace direct evacuation system, in accordance with various embodiments of the present invention;

FIG. 5B is a second perspective view of the cement wall panel of FIG. 5A;

FIG. 5C is a rear view of the cement wall panel of FIG. 5A;

FIG. 5D is a bottom view of the cement wall panel of FIG. 5A;

FIG. 6A is a first perspective view of a cement floor panel for a dropout section of an improved electric arc furnace direct evacuation system, in accordance with various embodiments of the present invention;

FIG. 6B is a second perspective view of the cement floor panel of FIG. 6A;

FIG. 6C is a third perspective view of the cement floor panel of FIG. 6A;

FIG. 6D is an end view of the cement floor panel of FIG. 6A;

FIG. 6E is a bottom view of the cement floor panel of FIG. 6A;

FIG. 7A is a cross-sectional view of a lower portion of a dropout section of an improved electric arc furnace direct evacuation system, taken along line 7-7 of FIG. 4, showing a first convective cooling flow pattern, in accordance with various embodiments of the present invention; and

FIG. 7B is a cross-sectional view of a lower portion of a dropout section of an improved electric arc furnace direct evacuation system, taken along line 7-7 of FIG. 4, showing a second convective cooling flow pattern, in accordance with various embodiments of the present invention.

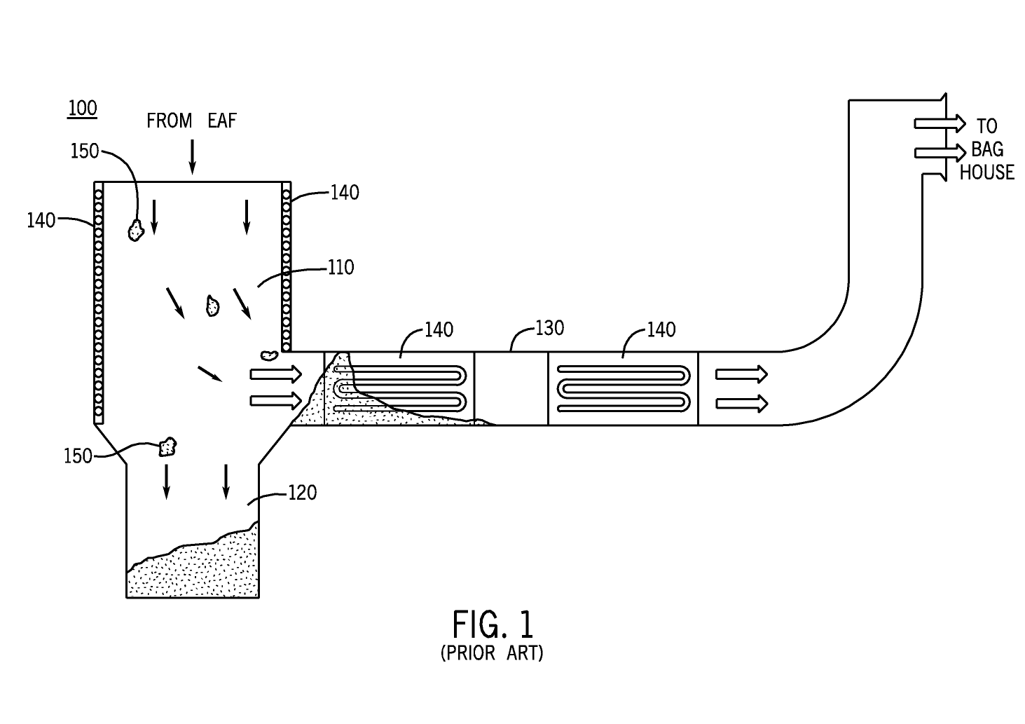

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be apparent to one of ordinary skill in the art that the present invention may be practiced without these specific details. In other instances, well known methods, procedures, components, and circuits have not been described in detail as not to unnecessarily obscure certain aspects of the present invention.

Generally speaking, various embodiments of the present invention provide for a direct evacuation system for an electric arc furnace (EAF) that greatly reduces or even eliminates the above-described issues with undesirable clogging in the ductwork. To that end, various embodiments provide an evacuation system that moves the EAF exhaust much more slowly through a dropout section to enable most, if not all, of the particulate to drop out into a dropout box.

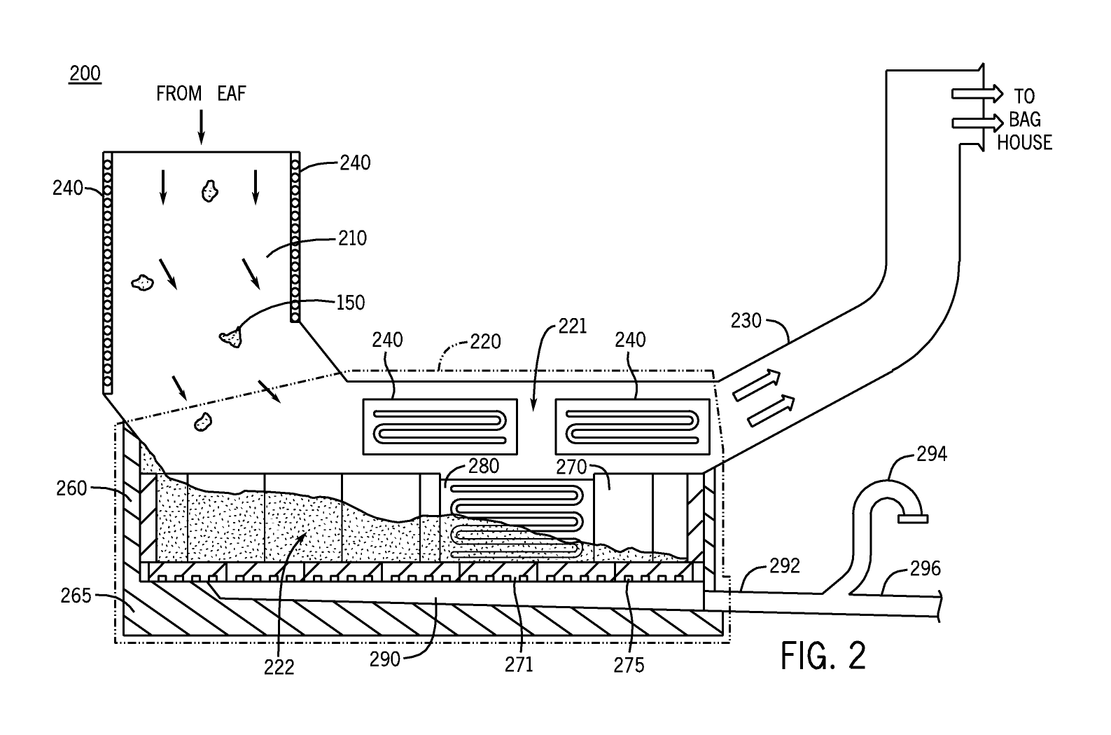

FIG. 2 shows a cross-sectional view of an EAF direct evacuation system 200, in accordance with various embodiments of the present invention. System 200 includes a combustion chamber 210 that receives the exhaust, including gasses and particulate 150 (i.e. products of combustion), from an EAF. The combustion chamber 210, or portions thereof, may be lined with one or more water-cooled panels 240. The exhaust then passes from the combustion chamber 210 into a dropout section 220. The dropout section 220 includes an upper portion 221 for permitting the gasses to pass therethough and a lower portion 222 defining a dropout box for collecting the particulate 150. The exhaust (now comprising little or no particulate 150) then passes from the dropout section 220 to exhaust ductwork 230, which leads to the baghouse, where exhausted air is cleaned and purified for release into the atmosphere.

System 200 represents a significant improvement over conventional EAF evacuation systems in that its configuration results in a significantly higher rate of particulate collection efficiency in the dropout section 220. This is achieved by significantly reducing the speed at which the exhaust passes through the dropout section 220, so as to permit the particulate 150 more time to drop out of the exhaust. In one embodiment, the dropout section 220 has an airspeed therethrough of less than 3100 feet per minute, and preferably less than 2100 feet per minute, and more preferably equal to or less than approximately 2050 feet per minute. This reduction in airspeed is initially accomplished by reconfiguring dropout section 220 so as increase its volume. For example, whereas the internal chambers of dropout boxes of prior EAF evacuation systems had volumes up to 3570 cubic feet, the dropout section 220 according to one embodiment may have an internal volume greater than 4000 cubic feet, and preferably greater than 5800 cubic feet, and more preferably equal to or greater than approximately 5870 cubic feet.

It should be appreciated that constructing a dropout section in accordance with some of the above embodiments may present difficulties from the perspective of cooling. The ducting of conventional EAF evacuation systems principally relies upon water-cooled panels to keep the ducting cool. However, water-cooled panels are expensive and require extensive water processing systems within the plant. Moreover, the more water-cooled panels that are installed in EAF ducting, the greater the likelihood that a panel will leak and thus require plant downtime to replace. Accordingly, various embodiments of the present invention provide for a dropout section 220 configuration that significantly reduces reliance upon water-cooled panels 240.

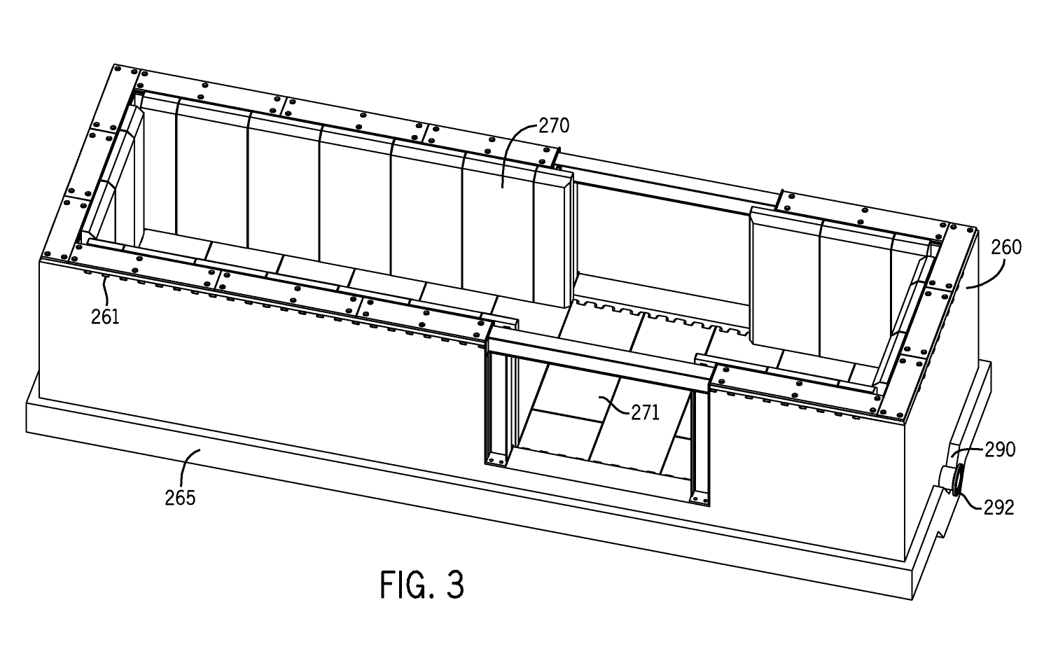

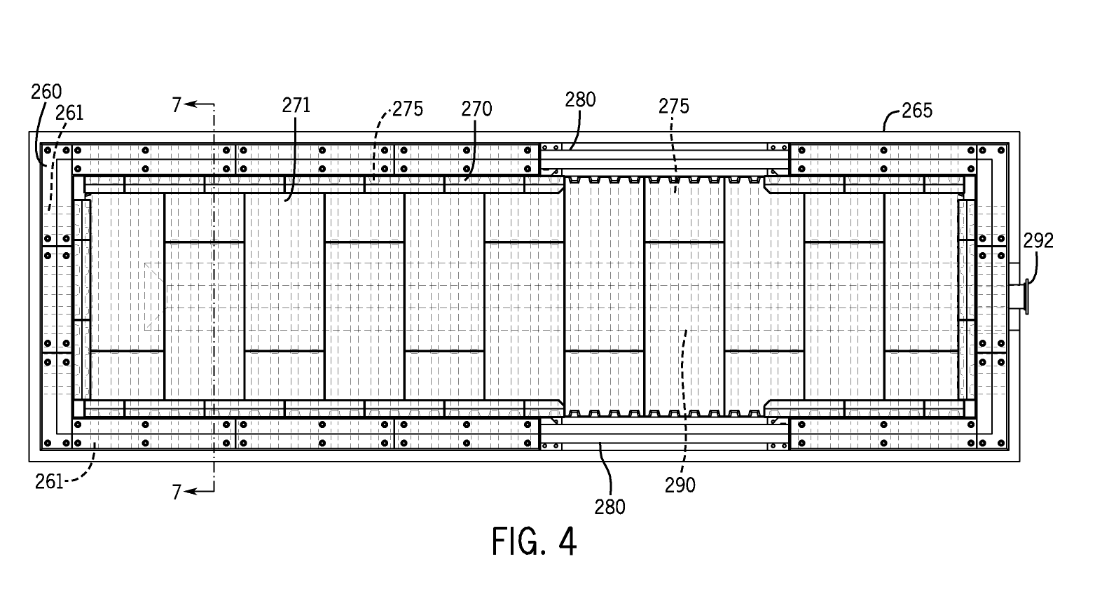

FIGS. 3 and 4 show perspective and plan views, respectively, of the lower portion 222 of dropout section 220, in accordance with various embodiments of the present invention. Instead of an expensive and high-maintenance water-based cooling system, the lower portion 222 of dropout section 220 utilizes a convective cooling system. To this end, the lower portion of dropout section 220 may be lined with a plurality of low cement, castable panels 270-271, which include a plurality of wall panels 270 and a plurality of floor panels 271. Preferably, the panels 270-271 are pre-fired so as to minimize or eliminate lengthy dryout times that would otherwise be required after the installation of a new panel 270-271.

By eliminating the use of water-cooled panels 240 from the lower portion of the dropout section 220, less delicacy is needed in removing the collected particulate 150 from the dropout section 220. For example, the particulate may be removed with a skid loader, instead of with a pneumatic jackhammer, which greatly speeds the cleaning process and therefore reduces plant downtime for cleaning and maintenance. To that end, the dropout section 220 may include one or more doors 280 (see FIGS. 2 and 4) that are sufficiently large to permit ingress and egress of a skid loader into and out of the dropout section 220. The doors 280 themselves may be water-cooled.

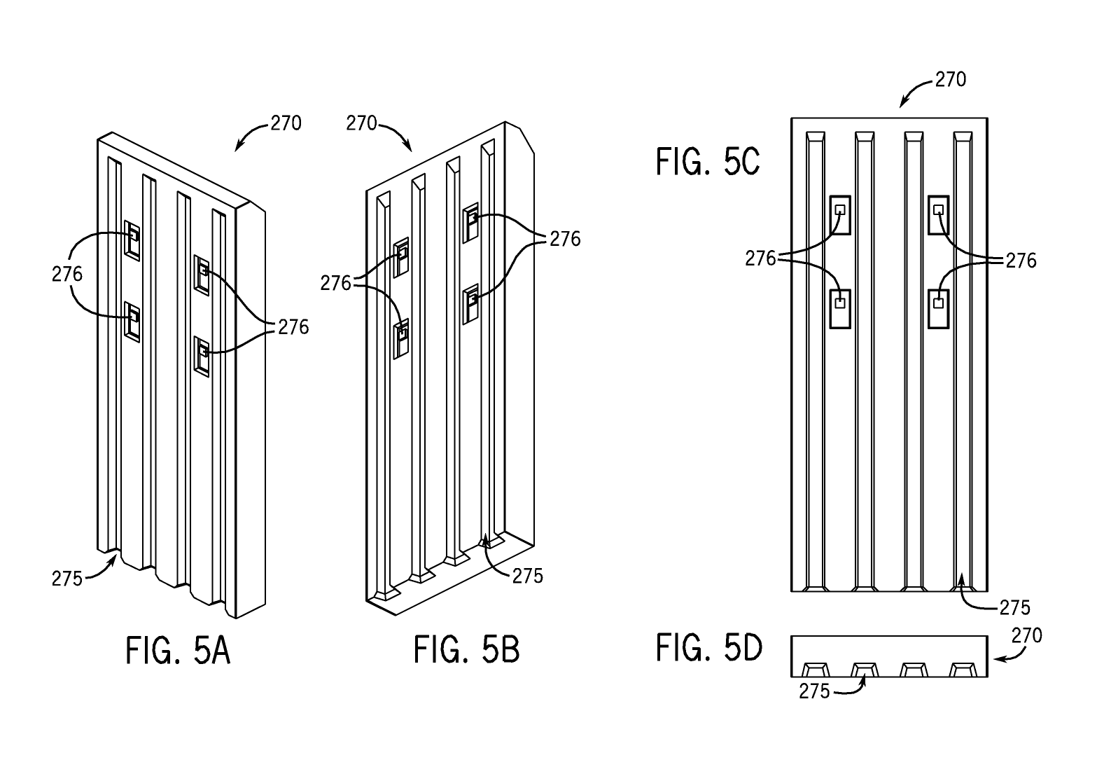

FIGS. 5A-D and 6A-E illustrate various views of a wall panel 270 and a floor panel 271, respectively, in accordance with various embodiments of the present invention. Wall panel 270 may include one or more hanger clips 276, which cooperate with aligned hooks (not shown) on walls 260 of dropout section 220 to enable the quick installation and/or removal of the wall panel 270. Panels 270-271 each include one or more channels 275 disposed along outward-facing sides thereof (i.e. the sides and/or edges facing the walls 260 or floor 265 of dropout section 220). As will be described further below, these channels 275 enable the convective cooling of the panels 270-271 and, thus, the lower portion of the dropout section 220.

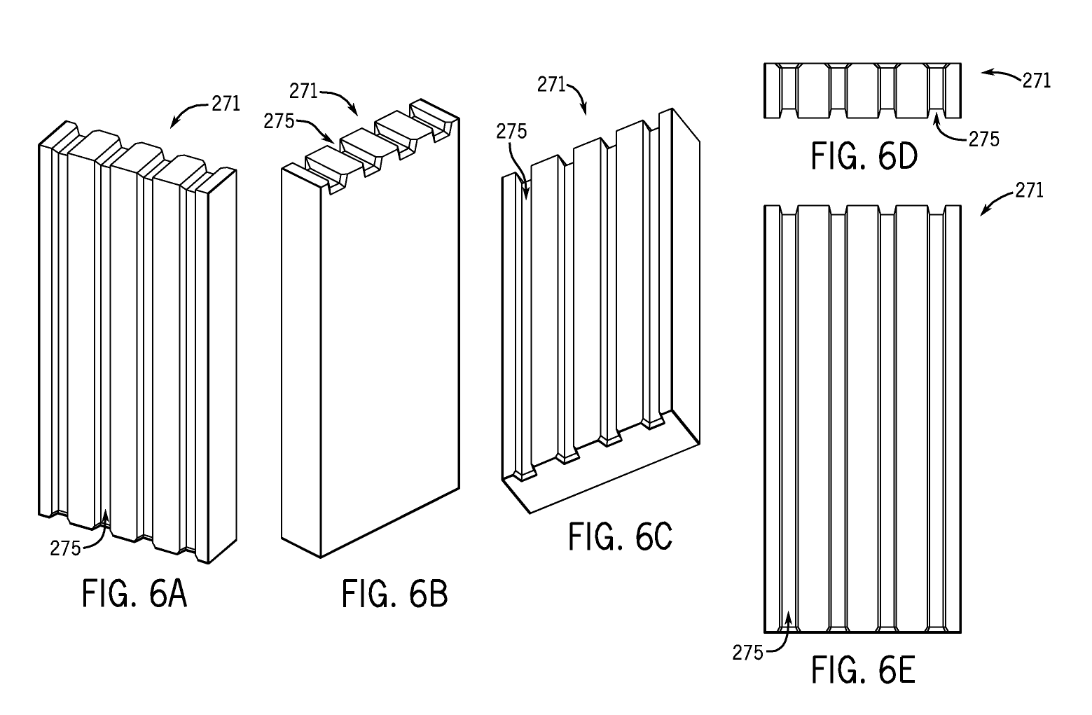

As shown in FIGS. 6A-E, the channels 275 of the floor panel 271 wrap around from a floor-facing side of the panel 271 to a wall-facing edge. It will be appreciated, however, that other configurations are possible, such as where the wall panel 270 has a channel 275 along multiple sides instead of the floor panel 271, or where both the wall panel 270 and the floor panel 271 only have channels 275 along a single side thereof. When the panels 270-271 are installed into the dropout section 220, they are preferably arranged so that the channels 275 along the wall-facing sides of the wall panels 270 generally align with the channels 275 along the wall-facing edge of the floor panels, so as to permit air to pass between the respective channels 275 of the wall panels 270 and the floor panels 271, to convectively cool the panels 270-271.

To further facilitate the convective cooling of dropout section 220, walls 260 of dropout section 220 may contain a plurality of air vents 261 (shown in FIGS. 3 and 4) that are generally aligned with the channels 275 of the wall panels 270, and the floor 265 may contain a drainage trench 290 disposed below at least some of the channels 275 of the floor panels 271. The drainage trench 290 may lead to drainage pipe 292 (see FIGS. 2 and 4), which may in turn have an air vent 294 and a water drain 296.

The drainage trench 290 and the drainage pipe 292 serve a dual purpose. They serve as a means of draining water from the dropout section 220 in the event that a water-cooled panel 240 leaks. Since adjacent floor panels 271 do not form a watertight/airtight seal, water from a leaky water-cooled panel 240 may pass through the gaps between adjacent floor panels 271, travel through channels 275 (if necessary), and then drain through drainage trench 290, drainage pipe 292 and water drain 296. This structural relationship enables evacuation operations to continue, despite a leak in a water-cooled panel 240.

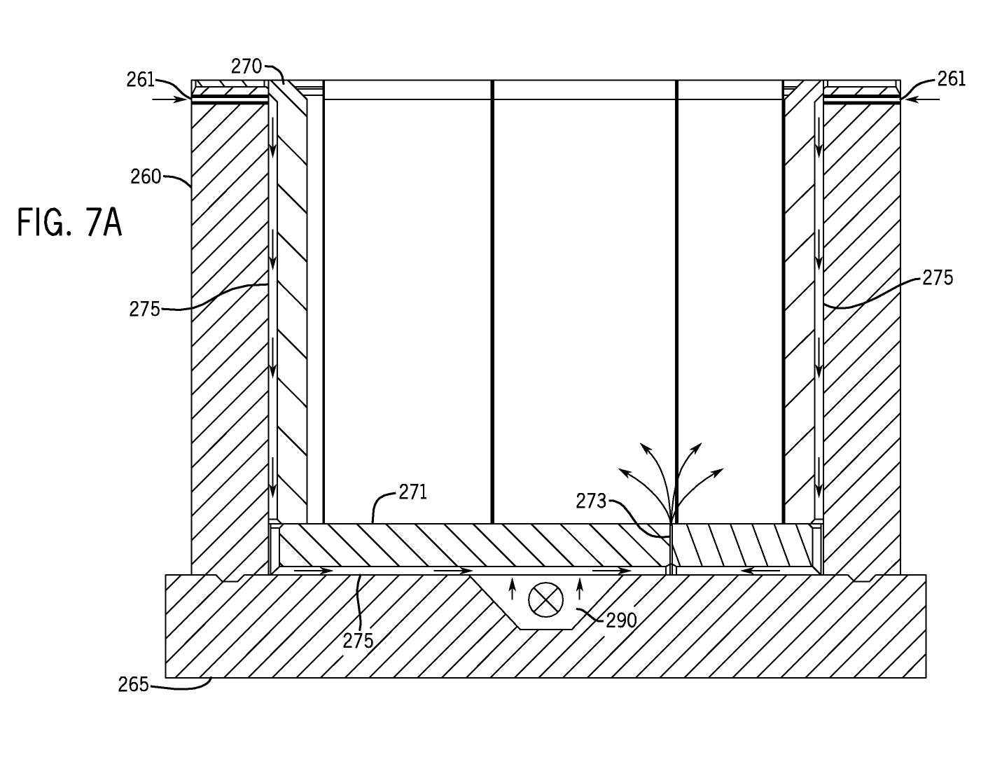

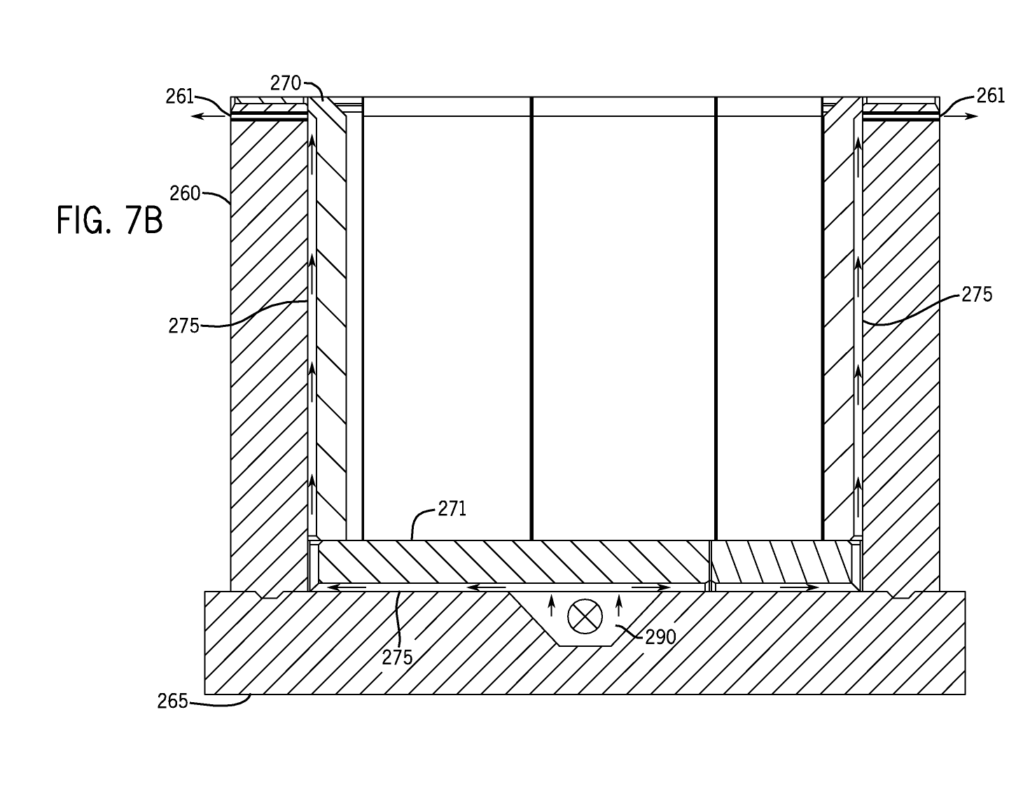

Drainage trench 290 and drainage pipe 292 also aid in the convective cooling of the dropout section 220. The cross-sectional views of FIGS. 7A and 7B show the lower portion of a dropout section, taken at line 7-7′ of FIG. 4, showing first and second convective cooling patterns, respectively, of the dropout section 220, in accordance with various embodiments of the present invention. Specifically, FIG. 7A shows an “active” convective cooling pattern in which the suction from the baghouse is the primary force driving the convection. In this operation, the suction from the baghouse causes air to be drawn into vents 261, down channels 275 of the wall panels 270, across channels 275 of the floor panels 271, up through spaces between adjacent floor panels 271, and out to the baghouse through exhaust ducting 230. Simultaneously, the baghouse also draws air into drain pipe 292 via air vent 294, into trench 290 (denoted in FIG. 7A by the “arrow tail” symbol), and up through spaces (such as space 273) between adjacent floor panels 271.

It will be appreciated that as particulate 150 and debris collect in the dropout section 220 and begin to block the spaces between adjacent floor panels, the suction from the baghouse will become less and less of a driver for the convection. At some point, the convective cooling pattern will transition from the active, baghouse-driven pattern shown in FIG. 7A to the passive, natural convection pattern shown in FIG. 7B, which is passively driven by the forces of natural convection. Accordingly, in the convection pattern of FIG. 7B, the natural tendency of heat to rise causes air to be drawn into drain pipe 292 via air vent 294, into trench 290, across channels 275 of the floor panels, up channels 275 of the wall panels 270, and out vents 261.

In the convective cooling patterns of either of FIGS. 7A and 7B, the movement of air through the channels 275 of panels 270-271 provides enough cooling to maintain the panels 270-271 at a sufficiently low operating temperature.

Thus, various embodiments provide for an EAF evacuation system that has a reconfigured dropout section that promotes a slower air speed, which not only greatly enhances particulate collection efficiency, but also increases the ease of cleaning. Both of these benefits lead to decreased downtime for maintenance and, thus, to a decrease in lost revenue. Further, the inclusion of convectively cooled, low cement castable panels in the dropout section provides additional benefits. In particular, it significantly reduces the amount of cooling water needed per square foot of dropout chamber, thereby reducing cost and risk for water leaks. The high strength of the panels also allows for faster cleaning with frontloading equipment, which is not possible with water-cooled panels due to the risk of mechanical damage. Moreover, if the panels are pre-fired, refractory dryout time is eliminated. Finally, the inclusion of an internal water drainage system permits continued operations in the event of water panel leakage.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An evacuation system for an electric arc furnace, comprising:
a combustion chamber downstream of the electric arc furnace, for receiving exhaust comprising gas and particulate from the electric arc furnace;
a dropout section downstream of the combustion chamber, for receiving the exhaust from the combustion chamber, for collecting the particulate, and for allowing the gas to pass through the dropout section to an exhaust duct, the dropout section having an air speed therethrough of less than 3100 feet per minute.

2. The evacuation system as recited in claim 1, in which the dropout section comprises an upper portion and a lower portion, and in which the lower portion comprises a wall, a floor and a pre-fired low cement castable panel disposed along at least a portion of the floor and/or the wall.

3. The evacuation system as recited in claim 2, in which the panel comprises a channel running along at least a portion of an outward-facing side of the panel, the channel allowing air to pass therethrough to convectively cool the panel.

4. The evacuation system as recited in claim 3, in which the panel is a wall panel disposed along at least a portion of the wall of the lower portion, and wherein the lower portion of the dropout section comprises a pre-fired low cement castable floor panel disposed along at least a portion of the floor and having a channel running along a floor-facing side and a wall-facing edge thereof that generally aligns with the channel of the wall panel so that air passes between the respective channels of the wall panel and the floor panel to convectively cool both the wall panel and the floor panel.

5. The evacuation system as recited in claim 4, in which the wall of the dropout section comprises an air vent passing therethrough that is generally aligned with the channel of the wall panel so that air passes through the air vent, between the ambient atmosphere outside the dropout section and the channel of the wall panel.

6. The evacuation system as recited in claim 3, wherein the panel is a first floor panel disposed along at least a portion of the floor, and wherein the lower portion of the dropout section further comprises:
a second, pre-fired low cement castable floor panel disposed along at least a portion of the floor of the lower portion and adjacent to the first floor panel, the second floor panel having a channel running along at least a portion of a floor-facing side thereof, which allows air to pass therethrough to convectively cool the second floor panel; and
a drainage trench disposed within the floor of the lower portion and below at least a portion of the channels of the first and second floor panels so that a fluid can pass between one or more of the channels of the floor panels and a space between the first and second floor panels and the drainage trench.

7. The evacuation system as recited in claim 6, wherein the fluid comprises air, and wherein the passage of the air between the floor panels and the drainage trench convectively cools the floor panels.

8. The evacuation system as recited in claim 6, wherein the fluid comprises water, and wherein the drainage trench drains the water away from the floor panels.

9. The evacuation system as recited in claim 1, wherein the dropout section comprises an upper portion and a lower portion, wherein walls and a floor of the lower portion are substantially lined with a plurality of pre-fired, low cement castable panels.

10. The evacuation system as recited in claim 9, wherein the upper portion comprises a wall and a water-cooled panel disposed along at least a portion of the wall of the upper portion.

11. The evacuation system as recited in claim 1, wherein the dropout section comprises a door sufficiently large to permit ingress and egress of a motorized skid loader into and out of the dropout section.

12. The evacuation system as recited in claim 11, wherein the door comprises a water-cooled panel disposed on an inward-facing side thereof.

13. The evacuation system as recited in claim 1, wherein the airspeed through the dropout section is less than 2100 feet per minute.

14. The evacuation system as recited in claim 1, wherein the airspeed through the dropout section is equal to or less than approximately 2050 feet per minute.

15. The evacuation system as recited in claim 1, wherein the dropout section defines an internal chamber having a volume greater than 4000 cubic feet.

16. The evacuation system as recited in claim 1, wherein the dropout section defines an internal chamber having a volume greater than 5800 cubic feet.

17. The evacuation system as recited in claim 1, wherein the dropout section defines an internal chamber having a volume equal to or greater than approximately 5870 cubic feet.

18. An evacuation system for an electric arc furnace, comprising:
a combustion chamber downstream of the electric arc furnace, for receiving exhaust comprising gas and particulate from the electric arc furnace;
a dropout section downstream of the combustion chamber, for receiving the exhaust from the combustion chamber, for collecting the particulate, and for allowing the gas to pass through the dropout section to an exhaust duct, the dropout section defining an internal chamber having a volume greater than 4000 cubic feet.

19. The evacuation system as recited in claim 18, in which the dropout section comprises an upper portion and a lower portion, and in which the lower portion comprises a wall, a floor and a pre-fired low cement castable panel disposed along at least a portion of the floor and/or the wall.

20. The evacuation system as recited in claim 19, in which the panel comprises a channel running along at least a portion of an outward-facing side of the panel, the channel allowing air to pass therethrough to convectively cool the panel.

21. The evacuation system as recited in claim 20, in which the panel is a wall panel disposed along at least a portion of the wall of the lower portion, and wherein the lower portion of the dropout section comprises a pre-fired low cement castable floor panel disposed along at least a portion of the floor and having a channel running along a floor-facing side and a wall-facing edge thereof that generally aligns with the channel of the wall panel so that air passes between the respective channels of the wall panel and the floor panel to convectively cool both the wall panel and the floor panel.

22. The evacuation system as recited in claim 21, in which the wall of the dropout section comprises an air vent passing therethrough that is generally aligned with the channel of the wall panel so that air passes through the air vent, between the ambient atmosphere outside the dropout section and the channel of the wall panel.

23. The evacuation system as recited in claim 20, wherein the panel is a first floor panel disposed along at least a portion of the floor, and wherein the lower portion of the dropout section further comprises:
a second, pre-fired low cement castable floor panel disposed along at least a portion of the floor of the lower portion and adjacent to the first floor panel, the second floor panel having a channel running along at least a portion of a floor-facing side thereof, which allows air to pass therethrough to convectively cool the second floor panel; and
a drainage trench disposed within the floor of the lower portion and below at least a portion of the channels of the first and second floor panels so that a fluid can pass between one or more of the channels of the floor panels and a space between the first and second floor panels and the drainage trench.

24. The evacuation system as recited in claim 23, wherein the fluid comprises air, and wherein the passage of the air between the floor panels and the drainage trench convectively cools the floor panels.

25. The evacuation system as recited in claim 23, wherein the fluid comprises water, and wherein the drainage trench drains the water away from the floor panels.

26. The evacuation system as recited in claim 18, wherein the dropout section comprises an upper portion and a lower portion, wherein walls and a floor of the lower portion are substantially lined with a plurality of pre-fired, low cement castable panels.

27. The evacuation system as recited in claim 26, wherein the upper portion comprises a wall and a water-cooled panel disposed along at least a portion of the wall of the upper portion.

28. The evacuation system as recited in claim 18, wherein the dropout section comprises a door sufficiently large to permit ingress and egress of a motorized skid loader into and out of the dropout section.

29. The evacuation system as recited in claim 28, wherein the door comprises a water-cooled panel disposed on an inward-facing side thereof.

30. The evacuation system as recited in claim 18, wherein the airspeed through the dropout section is less than 3100 feet per minute.

31. The evacuation system as recited in claim 18, wherein the airspeed through the dropout section is less than 2100 feet per minute.

32. The evacuation system as recited in claim 18, wherein the airspeed through the dropout section is equal to or less than approximately 2050 feet per minute.

33. The evacuation system as recited in claim 18, wherein the dropout section defines an internal chamber having a volume greater than 5800 cubic feet.

34. The evacuation system as recited in claim 18, wherein the dropout section defines an internal chamber having a volume equal to or greater than approximately 5870 cubic feet.

35. An evacuation system for an electric arc furnace, comprising:
a combustion chamber downstream of the electric arc furnace, for receiving exhaust comprising gas and particulate from the electric arc furnace; and
a dropout section downstream of the combustion chamber, for receiving the exhaust from the combustion chamber, for collecting the particulate, for allowing the gas to pass through the dropout section to an exhaust duct, the dropout section comprising:
an upper portion; and
a lower portion, the lower portion comprising:
an internal wall;
an internal floor; and
a pre-fired, low cement castable panel disposed along at least a portion of the floor and/or the wall, the panel having a channel running along at least a portion of an outward-facing side thereof, the channel allowing air to pass therethrough to convectively cool the panel.

36. The evacuation system as recited in claim 35, in which the panel is a wall panel disposed along at least a portion of the wall of the lower portion, and wherein the lower portion of the dropout section comprises a pre-fired low cement castable floor panel disposed along at least a portion of the floor and having a channel running along a floor-facing side and a wall-facing edge thereof that generally aligns with the channel of the wall panel so that air passes between the respective channels of the wall panel and the floor panel to convectively cool both the wall panel and the floor panel.

37. The evacuation system as recited in claim 36, in which the wall of the dropout section comprises an air vent passing therethrough that is generally aligned with the channel of the wall panel so that air passes between ambient atmosphere outside the dropout section and the channel of the wall panel, through the air vent.

38. The evacuation system as recited in claim 35, wherein the panel is a first floor panel disposed along at least a portion of the floor, and wherein the lower portion of the dropout section further comprises:
a second, pre-fired, low cement castable floor panel disposed along at least a portion of the floor of the lower portion and adjacent to the first floor panel, the second floor panel having a channel running along at least a portion of a floor-facing side thereof, which allows air to pass therethrough to convectively cool the second floor panel; and
a drainage trench disposed within the floor of the lower portion and below at least a portion of the channels of the first and second floor panels so that a fluid can pass between one or more of the channels of the floor panels and a space between the first and second floor panels and the drainage trench.

39. The evacuation system as recited in claim 38, wherein the fluid comprises air, and wherein the passage of the air between the floor panels and the drainage trench convectively cools the floor panels.

40. The evacuation system as recited in claim 38, wherein the fluid comprises water, and wherein the drainage trench drains the water away from the floor panels.

41. The evacuation system as recited in claim 35, wherein the dropout section comprises an upper portion and a lower portion, wherein walls and a floor of the lower portion are substantially lined with a plurality of pre-fired, low cement castable panels.

42. The evacuation system as recited in claim 41, wherein the upper portion comprises a wall and a water-cooled panel disposed along at least a portion of the wall of the upper portion.

43. The evacuation system as recited in claim 35, wherein the dropout section comprises a door sufficiently large to permit ingress and egress of a motorized skid loader into and out of the dropout section.

44. The evacuation system as recited in claim 43, wherein the door comprises a water-cooled panel disposed on an inward-facing side thereof.

45. The evacuation system as recited in claim 35, wherein the airspeed through the dropout section is less than 2100 feet per minute.

46. The evacuation system as recited in claim 35, wherein the airspeed through the dropout section is equal to or less than approximately 2050 feet per minute.

47. The evacuation system as recited in claim 35, wherein the dropout section defines an internal chamber having a volume greater than 4000 cubic feet.

48. The evacuation system as recited in claim 35, wherein the dropout section defines an internal chamber having a volume greater than 5800 cubic feet.

49. The evacuation system as recited in claim 35, wherein the dropout section defines an internal chamber having a volume equal to or greater than approximately 5870 cubic feet.
